(19) United States
(12) Patent Application Publication
(10) Pub. No.: US 2017/0193117 A1
(43) Pub. Date: Jul. 6, 2017

(54) System and Methods for Displaying a List of Content Items from Web Services by an Embeddable Web Application

(71) Applicants: Minh Reigen, South San Francisco, CA (US); David R. Wegman, San Francisco, CA (US); Chingwen Li, Lexington, KY (US)

(72) Inventors: Minh Reigen, South San Francisco, CA (US); David R. Wegman, San Francisco, CA (US); Chingwen Li, Lexington, KY (US)

(21) Appl. No.: 14/986,034

(22) Filed: Dec. 31, 2015

(51) Int. Cl. G06F 17/30; G06F 3/0484; G06F 3/0482; H04L 29/08; H04L 29/06

(52) U.S. Cl. CPC G06F 17/30867; H04L 67/02; H04L 67/42; H04L 67/34; G06F 3/0482; G06F 3/04847; G06F 17/30887

(57) ABSTRACT

A method of searching one or more content items from a web service is disclosed. The method includes loading a search application embedded on a client page and associating the search application with the web service. A filter panel is configured to display one or more web service parameters for use in searching for the one or more content items from the web service. The values corresponding to each of the one or more web service parameters is retrieved and a search query string is generated using a URL of the web service and the values corresponding to each of the one or more web service parameters. The method further includes sending the search query string to the web service, receiving a response from the web service, and configuring a results panel that includes a list of content items corresponding to the response.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Technical Field

The present invention relates generally to a system and methods of displaying a list of content items using a web application accessed using a web browser. Specifically, it relates to a system and methods of displaying a list of content from one or more web services using an application embedded in a client web page.

2. Description of the Related Art

Web services may host a wide range of types of information such as, for example, media content, statistical results, and medical data, among many others. A web service may return a list of content items in response to a user's request for the content items.

There have been many solutions for searching and/or displaying a list of content items from a web service including embeddable applications that were created to display content from a web service with settings that are specific for the web service. Using these solutions, it can be difficult for the user to configure the application to generate a new query or to query a different web service. For example, when a user wishes to customize existing embeddable solutions such as adding a new parameter or removing an existing parameter in the query, the user may have to modify the code of the solutions.

In instances where users wish to search for media content from more than one web service using the previous solutions, the user may have to switch from one web service to another in order to perform the search. This method of searching for content from a plurality of web services can be time-consuming since the user has to access each and every web service to search for content in every one of the web services.

Accordingly, there is a need for a system and methods for searching one or more web services for media content using a simple user interface that is not specifically associated with a back end web service to allow the user to create a query for multiple web services. There is a need for a system and methods that allow a user to customize the search including modifying the parameters of the search using a simple user interface.

### SUMMARY

A system and methods of searching and displaying a list of one or more content items from a web service are disclosed. The method includes loading a search application embedded on a client page and associating the search application with the web service. A filter panel is displayed having one or more parameters of the web service to be searched, and values for each of the one or more parameters from the filter panel is retrieved and a search query string is generated using a URL of the web service and the values for each of the one or more parameters. The method further includes sending the search query string to the web service, receiving a response from the web service, and displaying a results panel that includes a list of content items corresponding to the response.

From the foregoing disclosure and the following detailed description of various example embodiments, it will be apparent to those skilled in the art that the present disclosure provides a significant advance in the art of methods for searching for content items using an embeddable web application having customizable HTML controls that represent query parameters and is not associated with a specific web service specification. Additional features and advantages of various example embodiments will be better understood in view of the detailed description provided below.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 shows one example system having a network that connects a client device and a server and may be utilized in searching and displaying a list of content items from a service response.

FIG. 2 shows an example method for searching for one or more content files using a media search widget embedded on a client page and accessed using web browser.

FIG. 3 shows a web browser with an example configuration of widget embedded into a client page

FIG. 4 shows another example embodiment of widget 125 accessed using web browser 120.

### DETAILED DESCRIPTION OF THE DRAWINGS

It is to be understood that the disclosure is not limited to the details of construction and the arrangement of components set forth in the following description or illustrated in the drawings. The disclosure is capable of other example embodiments and of being practiced or of being carried out in various ways. For example, other example embodiments may incorporate structural, chronological, process, and other changes. Examples merely typify possible variations. Individual components and functions are optional unless explicitly required, and the sequence of operations may vary. Portions and features of some example embodiments may be included in or substituted for those of others. The scope of the disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

In addition, it should be understood that example embodiments of the disclosure include both hardware and electronic components or modules that, for purposes of discussion, may be illustrated and described as if the majority of the components were implemented solely in hardware.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block or combinations of blocks in the diagrams discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, can be implemented by special purpose hardware-based computer systems that perform the specified functions or steps, or combinations of special purpose hardware and computer instructions.

Disclosed are a system and methods for searching content from multiple web services using an embeddable web application having customizable HTML controls that represent query parameters that are not associated with a specific web service specification. The method includes determining if a user is accessing a client page having a search application embedded therein. Upon determining that the user is accessing the client page, displaying the search application embedded on the client page that is configured to search for one or more content items from a web service. The web application may include a filter panel method further includes generating a filter panel having one or more parameters of the web service to be searched, retrieving values of the one or more parameters from the filter panel; generating a search query string based on the values of the one or more parameters and the web service to be searched as configured using the search application; sending the search query string to the web service; receiving a response to the search query string from the web service, the response corresponding to results of the search performed using the filter panel; and generating a results panel that displays results of the search performed using the filter panel.

For the purposes of the present disclosure, the terms content, item, content item, media, or content media files may be used interchangeably. Content may refer to an object such as, for example a JavaScript Object Notation (JSON) object specifying an electronic media content such as, for example, an image, a video file, or an audio file that may be searched by a user from a web using through a web application. A JSON object may contain one or more content items. It will be understood that content may also refer to an unspecified list of items from the web application. The search may be performed using a media search widget that is embedded on a client page accessed by a user using a web browser. The content items may be saved or hosted on a server communicatively connected with the computing device, and the media search widget may perform the search by sending a search query from the computing device to the server to retrieve a list of content items matching the search query, as will be known in the art.

Web services may host a wide range of types of data, such as media content, statistical results, medical records, etc. A web service may return a list of content items at a user's request. The present invention describes a system to display content items from web services using one or more functions of an embeddable web application such as a widget implemented as a JavaScript application. The client web page may download and embed the JavaScript application without additional configuration. The present invention defines a simple user interface that is an embedded JSON object on the client web site. The JSON object has complete instructions on how to configure the application. The present invention allows user to add a new parameter or to remove an existing parameter in a query without modifying the code in application. In addition, the invention allows user to query data from more than one web service without having to switch from one web service to another.

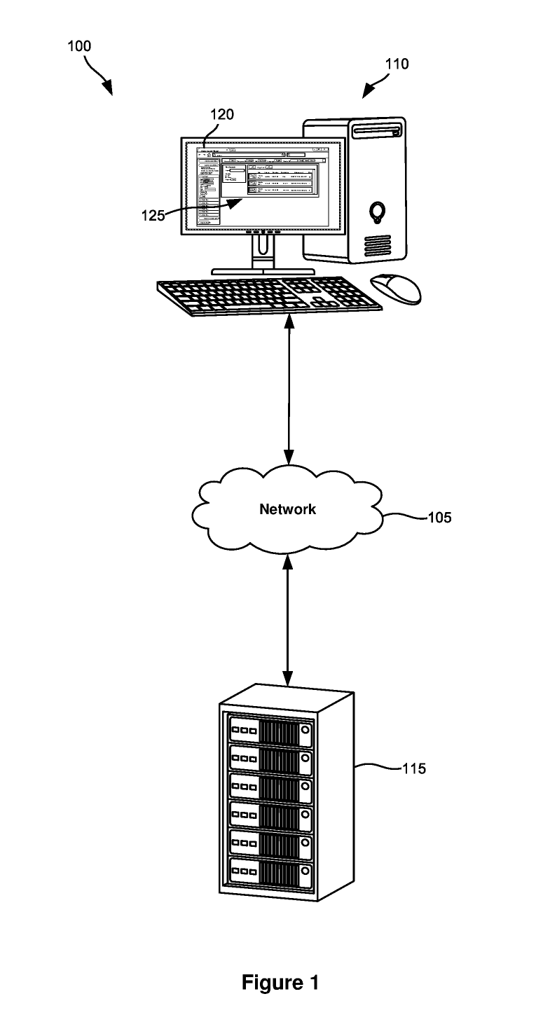

FIG. 1 shows one example system 100 having a network 105 that connects a client device 110 and a server 115 and may be utilized in searching and displaying a list of content items from a web service response. Client device 110 may include a web browser 120 for accessing a media search widget 125 that is downloaded from a server and embedded on a client page. Widget 125 may be used to search for one or more content items from one or more web services that may be accessed by a user using web browser 120, as will be discussed in greater detail below.

Network 105 may be any network, communications network, or network/communications network system such as, but not limited to, a peer-to-peer network, a hybrid peer-to-peer network, a Local Area Network (LAN), a Wide Area Network (WAN), a public network such as the Internet, a private network, a cellular network, a combination of different network types, or other wireless, wired, and/or a wireless and wired combination network capable of allowing communication between two or more computing systems, as discussed herein, and/or available or known at the time of filing, and/or as developed after the time of filing. Client device 110 and server 115 may be connected to network 105 through one or more network interfaces that allow each of the devices to send and receive information to and from the other.

Client device 110 may be any computing device that is used by a user to access a web service and to search for content hosted by the web service using the embedded web application. Client device 110 may be a personal computer and/or a mobile device such as a smart phone, or a tablet computer. Client device 110 may include a non-transitory computer readable storage medium installed with a client application such as, for example, a web browser 120 that may be used by the user of client device 110 to access a web page having one or more media content items. A web browser may be a software application installed in client device 110 that allows a user to view and interact with videos, audio tracks, albums, images and other media content items typically located on a web page at a website on a LAN or on a WAN such as, for example, the World Wide Web.

Server 115 may host the web service that provides content to client device 110 upon request or when a search for the content is initiated in client device 110. One or more media files in a particular format may be stored in server 115 along with information regarding the media files such as, for example, library name of the media file, contributor, date uploaded, type or format of the media file, among others. It will be known in the art that using web browser 120 to access the web service from server 115 includes sending a request from client device 110 to server 115 for the media content.

In the present disclosure, web browser 120 may be used to access the client web page having an embedded media search widget 125. Widget 125 may be a web application used to search for and display one or more content items from a web service. Widget 125 may be an embeddable application that is downloaded from a server, and then installed on a client web page. In one example embodiment, widget 125 includes filters that a user may configure in order to specify the search to be performed on the web service being accessed. Widget 125 may also include a widget editor that allows a user to customize the filters that will be used for searching, and a results panel where content search results are displayed.

In one example embodiment, widget 125 may perform its functions at the client-side which means that its code is run on the client machine or on client device 110, and more specifically on web browser 120. This is in contrast with server-side applications wherein the code is run on the server that is serving the web pages being accessed by the user. In one example embodiment, widget 125 may be implemented using client-side JavaScript and its functions may be performed or run on web browser 120.

Web service may be any application that is accessed via the web using web browser 120. For example, web service may be a website where one or more media content files are uploaded to and hosted by server 115 associated with the web service. The web service may be accessed using a uniform resource locator (URL), as will be known in the art. In the present disclosure, the web service may have one or more functions that may be accessed using a service API. For example, a query string that is used to search for content items from the web service may follow a general format according to the associated service API of the web service.

An example format of a query string for the web service may be http://domain.com/urlpath/resourcename?parameter1=value1&parameter2=value2. This example query string calls a function of the web service that invokes a resource having “resourcename” with specified parameters having values that correspond to “value1” and “value2”, respectively. This example query string will be used by widget 125 to query for content items as will be discussed in greater detail below.

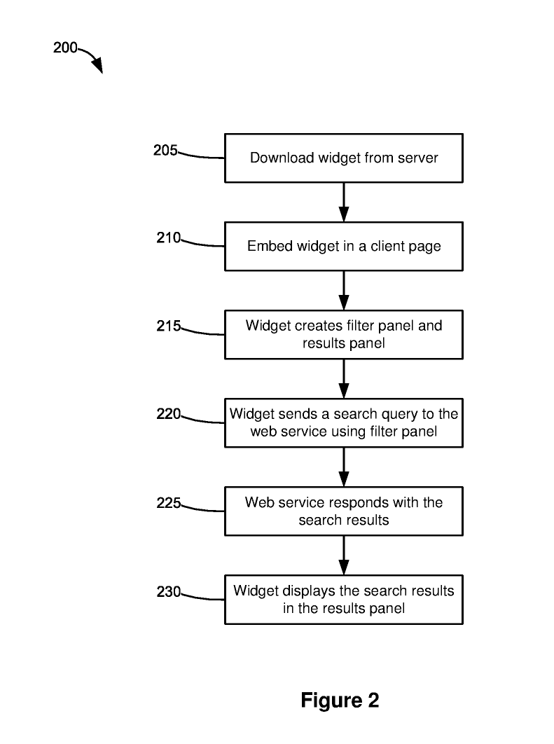

FIG. 2 shows an example method 200 for searching for one or more content files using a media search widget embedded on a client page and accessed using web browser 120. Method 200 may be performed using web browser 120 in client device 110.

At block 205, widget 125 may be downloaded from a server that hosts the widget application. In one example embodiment, widget 125 may be downloaded from a secure server that requires an authentication process to determine if the client device 110 and/or the user initiating the download are authorized to access widget 125. Once widget 125 is downloaded on client device 110, widget 125 may be embedded in a client page (at block 210) for use in searching one or more content items from the web service.

When the user accesses widget 125 using web browser 120, widget 125 may dynamically create a filter panel and/or a results panel (at block 215). The filter panel and the results panel may be created based on one or more settings that are provided by widget 125. In one example embodiment, the filter panel to be created may be based on a resource chosen by the user. The resource may correspond to the type of media that the user wishes to search using the web service such as, for example, video, audio, and image. The filter panel may generate and display the filters to be used based on the filter components that were created for the resource to be searched. For example, if the user specifies the Video resource to be the type of resource or media to be searched, the filter panel will create and display the one or more filters associated with the Video resource. The generation of filter components will be discussed in greater detail below.

The filter panel may be configured with a number of HTML controls representing parameters of a service API. When the user searches for one or more content items, a query string associated with the service API will be sent to server 115 associated with the web service. This query string represents the API call to the web service. The query string associated with the service API may follow a general format such as, for example, http://domain.com/urlpath/resourcename?parameter1=value1&parameter2=value2. Using this general query string format, a search query may be sent to the server wherein the “value1”, “value2”, portions of the query string is replaced with the values as set by the user using filter panel.

Using the filter panel, the user may configure widget 125 to search for items in a specific web service without specifically associating widget 125 with the back end web service, or knowing any low-level details about the web service. Using filter panel, properties are defined to specify a web service, including base URL, resource name, and a list of parameters for the service.

The parameter list defines one or more HTML controls. Each control represents a parameter in the query string associated with the service API of the web service. The application may provide implementation for common HTML controls, such as text input, dropdown box, checkbox, radio buttons, link, and control plugins, such as slider and calendar.

Widget 125 provides an application user interface that defines a list of objects, wherein each object in the list represents a backend web service. In one example embodiment, the list of objects may be a list of JavaScript Object Notation (JSON) objects which may follow a syntax for storing and exchanging data.

Below is an example list of at least two service JSON objects. In this example, there are two resources (e.g. video, and audio), each representing a different service as specified in the baseurl portion of the list, wherein the first object corresponds to a web service accessed using http://domain1.com/urlpath1/ and the second object corresponds to a second web application represented using http://domain2.com/urlpath2.

Below is one example embodiment of two filters representing two search parameters, “query,” and “fuzzy” set to search for video content items using the properties indicated in the example implementation:

“filter_panel”: {
“baseurl”: “http://domain1.com/urlpath1/”,
“resourcename”: “videos.json”,
“components”: [

{

“textinput”: {

“attributes”: {

“title”: “Keyword”,
“id”: “queryid”,
“name”: “query”,
“value”: “Nature”

}

}

},
{

“checkbox”: {

“attributes”: {

“title”: “Fuzzy”,
“id”: “fuzzycheckbox”,
“name”: “fuzzy”,
“value”: “true”

}

}

}

]

}

Below is one example embodiment of a filter representing a parameter, “direction”, and is used to search for audio content items using the properties indicated in the example implementation:

“filter_panel”: {

“baseurl”: “http://domain1.com/urlpath2/”,
“resourcename”: “audio.json”,
“components”: [

{

“dropdown”: {

“attributes”: {

“title”: “Direction”,
“id”: “direcdropdown”,
“name”: “direction”,
“optiontexts”: [

“Ascending”,
“Descending”

],
“optionvalues”: [

“up”,
“down”

],
“selectedoption”: 1

}

}

}

]

}

In this example implementation of a filter panel object, the filter panel includes a baseurl property, which is set to the base query URL of the web application. For example, the value for the baseurl may be set to http://domain.com/url/path.

The baseurl for the first filter is set to an example URL http://domain1.com/urlpath1 which indicates that the query search string will be sent to the web service using that example URL. The baseurl of the second filter is set to http://domain1.com/urlpath2 and when loaded, the second filter will search for content using the indicated URL path.

The filter panel may also include a resourcename property which is set to a valid resource name for the web application. The widget media search application programming interfaces (API) provide several resources to choose from such as, for example, “videos.json”, and “audio.json.” Other example APIs may also include “albums.json”, and “images.json.” Example APIs for each of the resources will be discussed in greater detail below.

In the first example embodiment of a filter, the resourcename property is set to “video.json” which indicates that the media to be searched using the first filter will be videos, and the parameters for the filters will use the video search API. In the second example embodiment of a filter, the resourcename property is set to “audio.json” which indicates that the media to be searched using the second filter will be audio content, and the parameters for additional filter options will be based on the audio search API.

In some example embodiments of widget 125, the baseurl and resourcename properties are required and widget 125 may create pre-determined filters with default parameter values for the properties.

The filter panel may include some additional options such as a title and a customizable setting for the size of the filter panel upon display. The title may be a description of the filter or the media search widget, and the filter panel size may be values for the width and height of the filter panel.

The filter panel may also have a components object which is an array list that is used to add and/or customize filters in a particular order. The components list may include elements that define HTML controls that represent query parameters.

In the first example filter, a “textinput” component is created having the attributes title set to “Keyword”, id set to “queryid”, name set to “query” and value set to “Nature”. This example text input component will create a text input HTML element having the attributes with the specified values. The title attribute may refer to the description of the text input HTML element, the ID to an identifier for the HTML element, and the value to an input of the text input HTML element. The name attribute of this example textinput element refers to the name of the parameter that the web service API provides. In this example, since “query” is used in the query to be sent to web service, this filter will be used in searching for video content items having “Nature” in any one of its title, descriptions, and/or tags. The “query” is a defined filter in the video search API of widget 125 which will be discussed in greater detail below.

In this example, widget 125 creates a filter panel containing two controls for “service 1”, a text input for “query” parameter and a checkbox for “fuzzy” parameter, and one control for service 2, a dropdown box for “direction” parameter. The user must specify the required attribute values for each control and may add optional attribute values. The “title” attribute describes the parameter. The “id” attribute is used to trigger a user request in the application, and the “name” is used to associate the HTML control with a parameter. In this example embodiment, the name attribute must match a parameter name of service API. Once the parameters are determined to be valid for searching the API, widget 125 generates a query string using the input values of baseurl, resourcename and values of parameters.

In continued reference to FIG. 2, at block 220 when the user accesses the page where widget 125 has been embedded, widget 125 makes an API call to the web service using the search query string containing the URL of the web service, and the values set in the parameters of the filter panel. The API call to the web service represents the search for one or more media content items made by widget 125 using parameters as specified by the user using the filter panel of widget 125. The API call may be in the form of a query string that is generated based on the input value on baseurl, resourcename, and values of parameters that may be specified by the user in the filters of widget 125.

At block 225, the web service responds with a list of items that corresponds to the API call of widget 125. The list of items includes the content search results from the search query sent from widget 125 to the web application that have been determined by server 115 to match the query string sent by widget 115 to the web service. For example, when an API call is made to a web service, the web service responds with a list of items in the following format: [{field1:value11, field2:value21, . . . }, {field1:value12, field2:value22, . . . }, . . . ].

At 230, widget 125 displays the item list in a results panel of widget 125. Upon receiving the list of items that corresponds to the content items search results, widget 125 parses the item list to identify the content items returned by the web application, and generates one or more layouts suitable for displaying the content item search results. Widget 125 then displays the content items in the results panel using the generated layout.

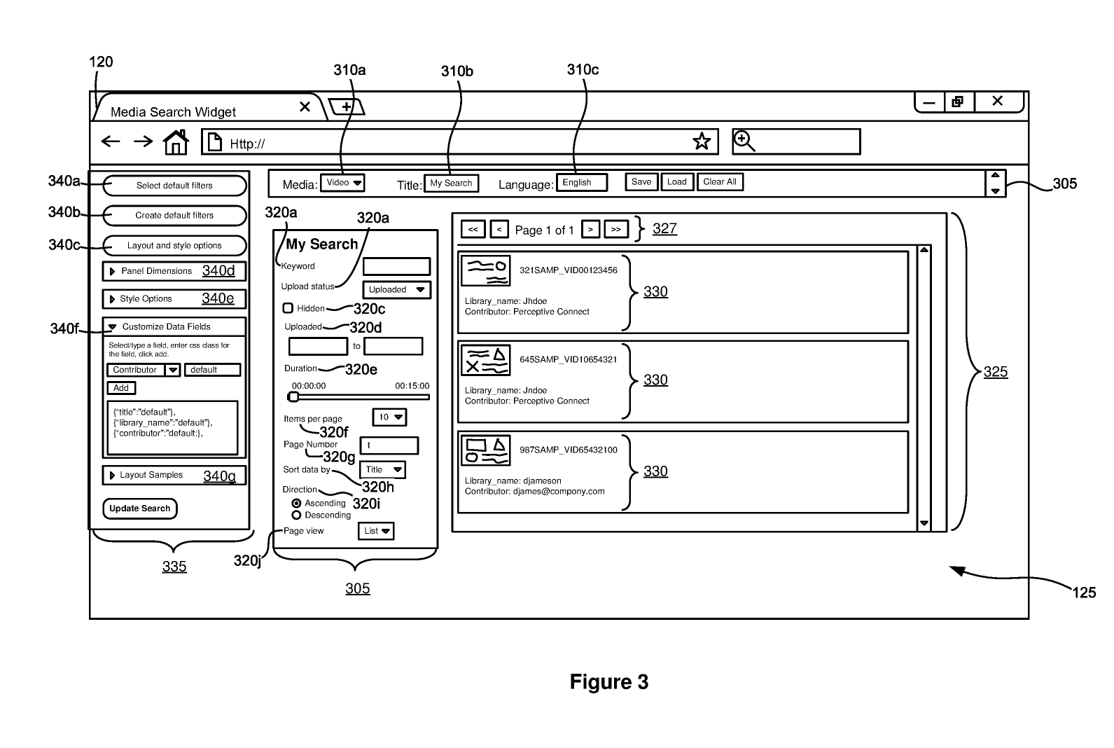

FIG. 3 shows a web browser 120 with an example configuration of widget 125 embedded into a client page. Widget 125 includes filter panel 305 that contains hypertext markup language (HTML) controls that represent parameters of a web service API. HTML controls may refer to HTML elements that may be displayed by web browser 120.

The example filter panel 305 of widget 125 shows the filter loaded for use in searching for content items from a web service. The example filter specifies the type of resource to be searched (e.g. “Video” resource 310a) as a dropdown menu, the title of the filter being used (e.g. “My Search” 310b), the language of the filter being used (e.g. “English” 310c). Filter panel 305 shows the loaded “My Search” filter which includes example filter components associated with the “My Search” filter such as, the “query” parameter titled “Keyword” to be used to search for content (320a), the upload status of the video (320b), a checkbox to indicate if the videos to be searched are hidden (320c), the upload date range of the videos to be searched (320d) and the duration of the video that may be customized by the user using horizontal range slider (320e).

Widget 125 also includes results panel 325 showing the content items 330 returned by web application in response to the query string sent by widget 125. Content items 325 are the results of the search performed using widget 125. The example filter “My Search” may also include options for displaying results in the results panel such as, for example, the number of items to display per page (320f), the page number to be displayed (320g), sort options for sorting the search results (320h), the direction at which the sorting is performed (320i), and the page view option for displaying the search results (320j). The page selector 327 in results panel 325 may correspond to the page number 320g as set in the My Search filter.

In the example filter panel 305, the type of resource to be searched is displayed as a drop-down menu “Video” 310a where a user can choose what type of content he or she wishes to search from the web application. The types of media include but are not limited to videos, audio files, images and albums. Each type of media may correspond to a resource, with each resource having a corresponding media search API.

Filters for Video and Audio Search API may be used when a search for content items having a “video” or an “audio” format is selected. Example HTML controls that are illustrated in FIG. 3 includes:

Query—This filter is used to search for the media item title, descriptions, and/or tags as set by the user. The HTML control for this filter may be a text input form.

Status—This filter is used to narrow down the search for audio and video content items based on the status of the content item. The HTML control for this filter may be a dropdown menu. Values for the dropdown menu may be set to statuses such as, for example, complete, in process, deleted, among others.

Hidden—This filter searches for audio and/or video content that may be marked as hidden in the server hosting the content items. The HTML control for this filter may be a checkbox having true and false values.

Upload Date Range—This filter refers to the upload date of the video or audio content item. The HTML control for this filter may be calendar (<YYYY/MM/DD>) fields that correspond to the start and end dates, respectively. The calendar fields may be jquery calendar fields.

Duration—This filter is used to search for video and/or audio content having a specified duration. The HTML control for this filter may be a horizontal range slider. Default values may be set such as, for example, a minimum and default value at 0 in seconds and a default maximum value at 900 in seconds).

Items Per Page—This filter may be used to set the number of content items to be displayed per page of the search results. The HTML control for this filter may be a dropdown menu with a list of a number of items to be shown on each page.

Page Number—This filter may be used to display the search results at a particular page number. The HTML control for this filter may be a text input with page number value.

Sort—This filter may be used to sort the search results returned by the web service. The HTML control for this filter may be a dropdown menu having sort options such as, for example, by Title, Date of Creation, Duration, Hit Counts, Play Counts, or by any of the custom fields used in searching for the content items.

Direction—When using the Sort filter, the Direction filter indicates if the results will be sorted in normal (up) or reverse (down) order. The HTML control for this filter may be radio buttons having Ascending and Descending values.

The filters of widget 125 are defined as a set of HTML controls such as the text input, dropdown menu, checkbox, radio buttons, range slider and calendar fields. Each of the HTML controls defines a set of attributes such as, for example:

TABLE 1
Example Set of Attributes for the Text Input HTML control of Widget 125

| Attributes | Required/Optional | Format |
|---|---|---|
| title | Required | Text |
| id | Required | Text |
| name | Required | Text |
| class | Optional | Text |
| style | Optional | Text |
| maxlength | Optional | Number |
| size | Optional | Number |
| disabled | Optional | True/False |
| read-only | Optional | True/False |
| value | Optional | Text |
| placeholder | Optional | Text |

TABLE 2
Example Set of Attributes for the Dropdown HTML control of Widget 125

| Attributes | Required/Optional | Format |
|---|---|---|
| title | Required | Text |
| id | Required | Text |
| name | Required | Text |
| class | Optional | Text |
| style | Optional | Text |
| size | Optional | Number |
| optiontexts | Required | Text array to be shown in |
| | | dropdown entries |
| optionalvalues | Required | Text array with search values |
| disabled | Optional | True/False |
| multiple | Optional | True/False |
| autofocus | Optional | True/False |
| selectedoption | Optional | Number of the Selected Option, |
| | | or Integer Array for Multiple |
| | | Selections |

TABLE 3
Example Set of Attributes for the Checkbox HTML control of Widget 125

| Attributes | Required/Optional | Format |
|---|---|---|
| title | Required | Text |
| id | Required | Text |
| name | Required | Text parameter name |
| class | Optional | Text |
| style | Optional | Text |
| checked | Optional | True/False |
| disabled | Optional | True/False |

TABLE 4
Example Set of Attributes for the Radio Buttons HTML control of
Widget 125

| | Required/ | |
|---|---|---|
| Attributes | Optional | Format |
| title | Required | Text |
| name | Required | Text |
| buttonids | Required | Text Array for Button IDs |
| buttonvalues | Required | Text Array with Search Values |
| checkedbutton | Option | Number to Indicate the Checked Button |
| class | Optional | Text |
| style | Optional | Text |

In another example embodiment, widget 125 may include elements that define HTML controls.

“filter_panel”: {

“baseurl”: “http://domain1.com/urlpath1/”,
“resourcename”: “video.json”,
“components”: [

{

“textinput”: {

“attributes”: {

“title”: “Contributor”,
“id”: “contribtext”,
“name”: “contributor”,
“class”: “query_input”,
“style”: “”,
“maxlength”: 100,
“size”: 10,
“disabled”: false,
“readonly”: false

}

}

}

]

}

In this example embodiment, a text input HTML component is created with attributes set under the “attributes” section of the implementation. In this example, a Contributor filter is added having specified values of the parameters of the text input HTML control. In this example, the “class”, “style”, “maxlength”, “size”, “disabled” and “readonly” fields are optional attributes of filter “Contributor” of widget 125.”

Results panel 325 shows the search results corresponding to the content items returned by the web service in response to the query search string sent by widget 125. The content items may be displayed in an HTML layout that may be pre-set in widget 125, or as customized by the user. When widget 125 makes the API call to the web service, the web service response with a list of items. Each item on the list contains a number of data fields. A data field can render a value of a certain data type such as, for example, a text, an image, or a number. Collection of data from a field is displayed in a suitable HTML layout which may be implemented as a table, a grid, a list, or a chart.

Results panel 325 may have the following implementation:

“results_panel”: {

“fields”: [

{

“video_id”: {

“name”: “Video ID”,
“type”: “text”

}

},
{

“title”: {

“name”: “Title”,
“type”: “text”

}

}

]

}

The fields list specifies data fields associated with an item. Each field may opt to use a default class for the resource, or a custom class as specified by the user. In this example, the results panel will display the data fields “video_ID” corresponding to an identifier of the video content results, and the “title” corresponding to the title of the video content results.

Another example implementation of results panel 325 may have the following details:

“results_panel”: {

“fields”: [

{

“track_id”: {

“name”: “Track ID”,
“type”: “text”

}

},
{

“plays_count”: {

“name”: “Plays”,
“type”: “number”

}

}

]

}

In this example, results panel 325 may display data fields “track_id” corresponding to an identifier of a track or audio content results, and the “plays_count” which corresponds to the number of plays the audio content results may have.

In continued reference to FIG. 3, widget 125 may also include a widget builder 335 where user may configure settings to be used in the filter options in filter panel 305 and results panel 325. In the example widget builder shown in FIG. 3, a user may select default filters 340a, create default filters 340b, set layout and style options 340c, set the panel dimensions 340d for at least one of the filter and the results panels, modify the look of the panels in style options 340e, customize data fields 340f and Layout Samples 340g showing pre-set layouts that the user may use.

The example Customize Data fields 340f shows the addition of three item fields namely, title, library name and contributor to be shown in the content items 330 in results panel 325. The addition of the three fields may be called from the API and added to the search using the example format:

{“title”:“default”},

{“library_name”:“default”},

{“contributor”:“default:},

The three fields may be chosen from the dropdown menu provided under the Customize Data Fields 340f, and the “default” value also added using the text input form. After updating the search, the three fields Title, Library Name, and Contributor are then displayed in results panel 325 along with the corresponding values of the search results.

Any change in the value of a parameter on the filter panel 305, and/or any changes to the filter options in widget builder 335 trigger a new search query to the web service and a corresponding response from the web service. The new response from the web service is then sent to the web browser and displayed on results panel 325.

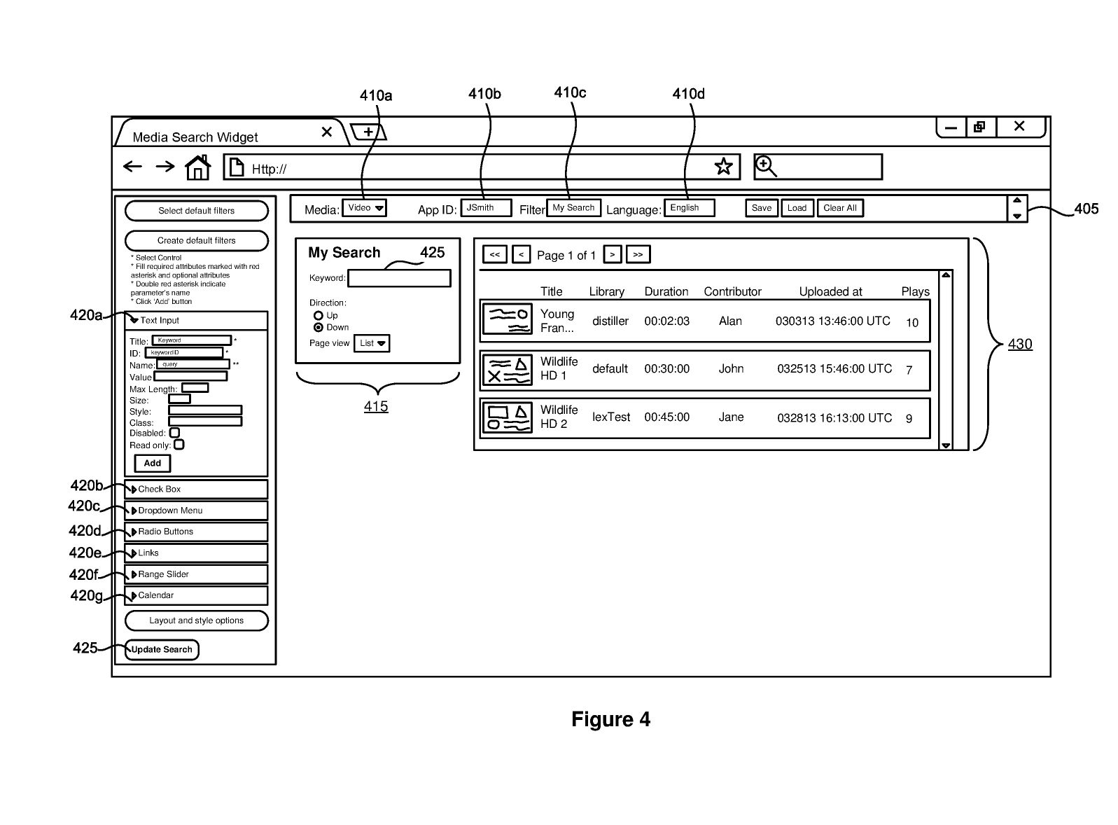

FIG. 4 shows another example embodiment of widget 125 accessed using web browser 120. Filter panel 405 includes resource or media selector 410a, company ID 410b, filter title 410c, and language selector 410d.

Filter panel 405 shows resource selector 410a set to “Video” which indicates that the type of media to be searched using My Search filter 415 would be video content items. Since videos have been chosen as the resource for My Search filter 415, the filter and the filter options to be loaded will be based on the video search API discussed above.

Filter panel 405 also includes an example filter App ID 410b which is set to “JSmith”. In one example embodiment, widget 125 may be configured to search for content items in a number of web applications, each web applications having an identifier. In this example embodiment, a user may set which application to search for content items using the App ID 410b text input form. It will be understood that setting a specific application identifier would automatically set the baseurl value of widget 125 which would be used for creating the query search string.

Filter panel 405 also includes the Filter input form 410c, which specifies the filter to be used for searching. In one example embodiment, selecting the filter, which in this example is the “My Search” filter 415, will load all the filter options and/or HTML controls that have been created for that particular filter. In this example embodiment, “My Search” filter includes Keyword 420a, Direction 420b and Page View 420c filter options.

Widget 125 may also allow a user to create default filters for the search filter being loaded using available HTML controls. In this illustrative embodiment, a Text Input HTML control 420 is being added by a user who has entered values for the “Title”, “ID”, and “Name” parameters. The Text Input HTML control 420 will be added to My Search filter 415. The attributes of the Text Input HTML controls may correspond to the attributes listed in Table 1. Example Set of Attributes for the Text Input HTML control of Widget 125.

In this example embodiment, the “Title” parameter refers to the description of the text input control which is reflected in My Search 415. The “Title” parameter is set to “Keyword” which is shown beside the text input form to describe text input form 425. The “ID” parameter is set to “keywordID” which refers to the identifier of this particular text input control, while “Name” is set to “query” which refers to the parameter of text input control 420 as defined in the video search API of widget 125. Since the resource of this example My Search filter is set to video, the filters to be used will be based on the video search API. The value specified on the “Name” attribute of Text Input HTML control will the correspond to the “Query” filter in the video search API which is a filter used to search for the media item title, description, and/or tags, as discussed with respect to the video search API.

Other HTML controls that may be added as a filter include but is not limited to Checkbox 420b, Dropdown Menu 420c, Radio Buttons 420d, Links 420e, Range Slider 420f, Calendar 420g. When added, each of the HTML controls should correspond to a particular type of filter or parameter (e.g. Query, IDs, Tags, Upload Date Range, Duration, etc.), as defined in the API of the resource being searched.

After adding a filter, the search may be updated using Update Search button 425. The changes may then be reflected in My Search 415 and the results of the search displayed in Results panel 430. Any changes made in the values of the attributes of the HTML controls of My Search 415 may trigger a response from the web service “JSmith”, returning any and all content items that were determined by server 115 to match the search query of widget 125.

One example implementation of a complete widget 125 may have the following configuration:

Var configOptions =
{
“appoptions”:{

```
  “container_div”:“my_container”,
  “language”:“language_es”,
  “cookieID”:“1234”
```

```
  },
  “services”:[
```

{

“filter_panel”: {

“baseurl”: “http://abc.def.co/companies/lexington/”,
“resourcename”: “videos.json”,
“filter_div”: “my_custom_div_1”,
“title”: “Service One”,
“filter_panel_size”: {
“width”: 250,
“height”: 200
},
“components”: [
{

“textinput”: {

```
“attributes”: {
  “title”: “Keyword Search”,
  “id”: “queryid”,
  “name”: “query”,
```

“class”: “query_input”,
“style”: “”,
“maxlength”: 100,
“size”: 10,
“disabled”: false,
“readonly”: false,
“value”: “test”

}

}

```
  },
  {
```

“checkbox”: {

```
  “attributes”: {
  “title”: “Fuzzy”,
  “id”: “fuzzycheckbox”,
  “name” : “fuzzy”,
```

“value”: “true”

}

```
  }
  }
]
```

```
  },
  “results_panel”: {
```

“results_panel_size”: {
“width”: 600,

“height”: 700

```
},
“results_div”:“my_results_div_1”,
“results_loading_div”:“my_results_loading_div_1”,
“fields”: [
  {“video_id”:“defaultclass”},
  {“title”:“titleclass”}
]
```

}

```
  },
  {
```

“filter_panel”: {

```
“baseurl”: “http://abc.def.co/companies/lexington/”,
“resourcename ”: “tracks.json”,
“filter_div”: “my_custom_div_2”,
“title”:“Service Two”,
“filter_panel_size”: {
“width”: 250,
  “height”: 150
},
“components”: [
  {
```

“dropdown”: {

```
  “attributes”: {
  “title”: “Direction”,
  “id”: “direcdropdown”,
  “name”: “direction”,
```

```
“optiontexts”: [
  “Ascending”,
  “Descending”
```

```
  ],
  “optionvalues”: [
```

```
  “up”,
  “down”
],
```

```
  “selectedoption”: 1
  }
```

}

}
]

```
  },
  “results_panel”: {
```

“results_panel_size”: {
“width”: 300,

“height”: 350

```
},
“results_div”:“my_results_div_2”,
“results_loading_div”:“my_results_loading_div_2”,
“fields”: [
  {“track_id”:“defaultclass”},
  {“plays_count”:“pcclass”}
]
```

}

}

]
}

In the example implementation of widget 125, “Service One” will be created for searching videos on base url, http://abc.def.co/companies/lexington. The filter will include a query filter presented as a text input HTML control titled “Keyword Search,” and a Fuzzy checkbox filter titled “Fuzzy.” The results panel for Service One will display the Video ID and Title data fields. “Service Two” will also be created for search audio track resources on base URL http://svc.psft.co/companies/lexington. Service Two includes a dropdown menu for the Direction filter, and will display the Track ID and Plays Count data fields.

Widget 125 defines the following parameters for the Video and Audio Search API which may be used when a search for content items having a “video” or an “audio” format is selected. These parameters may be server-specific settings. The default control for each parameter is also indicated:

Query—This filter is used to search for the media item title, descriptions, and/or tags as set by the user. The HTML control for this filter may be a text input form.

IDs—This filter may be used to search for video and/or audio IDs. The HTML control for this filter may be a text input form or a comma-separated list.

Tags—This filter may be used to search for one of several properties that are attached to a content item to help users find and organize the items. The HTML control for this filter may be a text input form or a comma separated list.

Upload Date Range—This filter refers to the upload date of the video or audio content item. The HTML control for this filter may be calendar (<YYYY/MM/DD>) fields that correspond to the start and end dates, respectively. The calendar fields may be jquery calendar fields.

Duration—This filter is used to search for video and/or audio content having a specified duration. The HTML control for this filter may be a horizontal range slider. Default values may be set such as, for example, a minimum and default value at 0 in seconds and a default maximum value at 900 in seconds).

Hits—This filter is used to search for video and/or audio content having a specified number of hits or instances of being accessed. The HTML control for this filter may be a horizontal range slider.

Plays—This filter is used to search for video and/or audio content having a user-specified number of plays. The HTML control for this filter may be a horizontal range slider.

Contributor—This filter may be used to search for a name of the uploader of the audio and/or video content. The HTML control for this filter may be a text input form.

Status—This filter is used to narrow down the search for audio and video content items based on the status of the content item. The HTML control for this filter may be a dropdown menu. Values for the dropdown menu may be set to statuses such as, for example, complete, in process, deleted, among others.

Hidden—This filter searches for audio and/or video content that may be marked as hidden in the server hosting the content items. The HTML control for this filter may be a checkbox having true and false values.

Custom fields—Widget 125 may also allow users to create custom filters in the following example format: custom_fields[<field name>]-value[<value>]-text input.

Verbosity—This filter may be presented as a dropdown menu having low, medium and high options.

Sort—This filter may be used to sort the search results returned by the web service. The HTML control for this filter may be a dropdown menu having sort options such as, for example, by Title, Date of Creation, Duration, Hit Counts, Play Counts, or by any of the custom fields used in searching for the content items.

Direction—When using the Sort filter, the Direction filter indicates if the results will be sorted in normal (up) or reverse (down) order. The HTML control for this filter may be radio buttons having Ascending and Descending values.

Page—This filter may be used to display the search results at a particular page number. The HTML control for this filter may be a text input with page number value.

Per Page—This filter may be used to set the number of content items to be displayed per page of the search results. The HTML control for this filter may be a dropdown menu with a list of a number of items to be shown on each page.

When the user chooses to search for an album and indicates this selection using media dropdown menu 310a, widget 125 may use at least two filters for searching for albums using an Album Search API. An example Album Search API may include the following filters:

Page—This filter may be used to display the search results at a particular page number. The HTML control for this filter may be a text input with page number value.

Per Page—This filter may be used to set the number of content items to be displayed per page of the search results. The HTML control for this filter may be a dropdown menu with a list of a number of items to be shown on each page.

For searching images, widget 125 may use the Image Search API which may include the following available filters:

Query—This filter is used to search for the title, descriptions, and/or tags of the images hosted in the web application, and as entered by the user. The HTML control for this filter may be a text input form.

IDs—This filter may be used to search for image identification numbers or IDs. The HTML control for this filter may be a text input or a comma-separated list.

Tags—This filter may be used to specifically search for images having a specified tag. The HTML control for this filter may be a text input form or a comma separated list.

Upload Date Range—This filter may be used to search for images that have been uploaded to the web application at a certain date range. The HTML control for this filter may be two jquery calendar (<YYYY/MM/DD>) fields that correspond to the start and end dates, respectively.

Status—This filter is used to narrow down the search for image content items based on the status of the images. The HTML control for this filter may be a dropdown menu with example statuses such as, for example, complete, deleted, or all.

Custom fields—Widget 125 may also allow users to create custom filters in the following example format: custom_fields[<field name>]-value[<value>]-text input.

Sort—This filter may be used to sort the search results returned by the web service. The HTML control for this filter may be a dropdown menu having sort options such as, for example, sorting the search results by Title, Upload Date, Resolution, Position, Original File Size, Orientation, or by any of the custom fields that may have been used in searching for the content items.

Direction—When using the Sort filter, the Direction filter indicates if the results will be sorted in normal (up) or reverse (down) order. The HTML control for this filter may be radio buttons having Ascending and Descending values.

Page—This filter may be used to display the search results at a particular page number. The HTML control for this filter may be a text input with page number value.

Per Page—This filter may be used to set the number of content items to be displayed per page of the search results. The HTML control for this filter may be a dropdown menu with a list of a number of items to be shown on each page.

Fuzzy—A fuzzy filter may also be used to search for image content items. The HTML control for this filter may be a checkbox having true or false values.

Publisher—This filter may be used to specify the publisher of the image content items the user wishes to search. The HTML control for this filter may be a text input where the user may enter the specific publisher name.

Width—This filter may be used to specify a range of width of the images to be searched. The HTML control for this filter may be a horizontal range slider used to set the minimum and maximum width values of the images to be searched.

Height—This filter may be used to specify a range of height values of the images to be searched. The HTML control for this filter may be a horizontal range slider used to set the minimum and maximum height values to be used as a criterion for searching images.

The above APIs include defined Page and Per Page options. The Page option is used to indicate at which page media items that are results of the search as to be displayed, which may be at a page number value as set by the user. The Per Page option shows the specified number of items on each page. The default value may be set at 100 (the maximum), but a lower value can be specified by the user, if desired.

It will be understood that the example applications described herein are illustrative and should not be considered limiting. It will be appreciated that the actions described and shown in the example flowcharts may be carried out or performed in any suitable order. It will also be appreciated that not all of the actions described in FIG. 2 need to be performed in accordance with the example embodiments of the disclosure and/or additional actions may be performed in accordance with other example embodiments of the disclosure.

Many modifications and other example embodiments of the disclosure set forth herein will come to mind to one skilled in the art to which these disclosure pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of searching and displaying one or more content items from a web service, comprising:
loading a search application having a filter panel and a results panel embedded on a client page;
associating the search application with the web service;
displaying the filter panel having one or more web service parameters for use in searching for the one or more content items from the web service;
retrieving one or more values entered by a user on the filter panel, each of the one or more values corresponding to the one or more web service parameters;
generating a search query string using a uniform resource locator (URL) of the web service and the one or more values corresponding to the one or more web service parameters;
sending the search query string to the web service;
receiving a response to the search query string from the web service, the response corresponding to the one or more content items returned by the web service from the search performed using the search query string; and
configuring the results panel to display a list of the one or more content items of the response of the search performed using the search query string from the filter panel.

2. The method of claim 1, wherein the loading the search application embedded on the client page is performed using a web browser, and wherein the associating, the configuring the filter panel, the retrieving, the generating, the sending, the receiving and the configuring the results panel are executed on the web browser through the search application.

3. The method of claim 1, further comprising determining if each of the one or more web service parameters in the filter panel corresponds to a valid web service parameter for the one or more content items hosted by the web service.

4. The method of claim 1, further comprising customizing the filter panel by adding a web service parameter to the one or more web service parameters of the filter panel, the web service parameter added corresponding to a valid web service parameter for the one or more content items hosted by the web service.

5. The method of claim 1, further comprising customizing the results panel by adding a web service parameter that displays information about the one or more content items returned by the web service.

6. The method of claim 1, further comprising parsing the response to the search query string received from the web service to extract the list of one or more content items for displaying in the results panel.

7. The method of claim 1, wherein the associating the search application with the web service is performed by adding a URL of the web service to the search query string.

8. A computing device having a non-transitory computer-readable storage medium, the storage medium having one or more instructions for displaying one or more content items retrieved from a web service, the one or more instructions comprising:
accessing a client page using a web browser, the client page having an embedded web application for use in searching for the one or more content items from the web service;
setting the embedded web application to search for the one or more items from the web service;
displaying one or more input options in the embedded web application, the one or more input options having values that correspond to one or more filters to be used in searching for the one or more content items;
retrieving the values from the one or more input options;
generating a search query string based on the web service added to the search application and the values from the one or more input options;
sending the search query string to the web service;
receiving a response from the web service, the response corresponding to the one or more content items that match the search query string; and
displaying the one or more content items.

9. The computing device of claim 8, wherein the setting the embedded web application to search for the one or more items from the web service includes adding a URL of the web service in the search query string.

10. The computing device of claim 9, wherein the sending the search query string to the web service includes making an application programming interface (API) call to the web service using the URL of the web service and the values of the one or more input options.

11. The computing device of claim 8, further comprising setting the embedded web application to search for one or more content items from a second web service.

12. The computing device of claim 8, wherein the displaying the one or more input options includes displaying one or more hypertext markup language (HTML) elements that allow a user to input data corresponding to the one or more filters.

13. The computing device of claim 8, wherein the displaying the one or more input options includes displaying the one or more input options that correspond to web service parameters for use in searching the one or more content items from the web service.

14. A system for searching and displaying a list of one or more content items, comprising:
a client device having a web browser for use in accessing a client page;
the client page having a search application embedded therein; and
the search application having a filter panel that is displayed when a user accesses the client page having the search application embedded therein, the search application having one or more instructions to:
set a web service from which the one or more content items will be searched using the search application;
display one or more input options in the filter panel, the one or more input options representing one or more web service parameters that correspond to a search criteria for use in searching the one or more content items in the web service;
retrieve values entered in the one or more input options, the values corresponding to the one or more web service parameters;
generate a search query string using the values entered in the one or more input options;
query for the one or more content items by sending the search query string to the web service;
receive a response to the query from the web service, the response including the list of one or more content items; and
display the list of one or more content items.

15. The system of claim 14, wherein the search application displays the list of one or more content items in a results panel.

16. The system of claim 14, wherein the search application parses the response to the query received from the web service to extract the list of the one or more content items.

17. The system of claim 14, wherein the search query string generated by the search application includes a base URL of the web service.

18. The system of claim 14, wherein the search application sends the search query string to the web service as an API call to the web service.

19. The system of claim 14, wherein the search application is downloaded from a server and embedded on the client page.

20. The system of claim 14, wherein the search application is a client-side application that performs the one or more instructions on the web browser while the client page is being accessed by the user.
